(19) United States
(12) Patent Application Publication
(10) Pub. No.: US 2024/0187981 A1
(43) Pub. Date: Jun. 6, 2024

(54) METHOD AND APPARATUS FOR OPERATING ENHANCED NON-PUBLIC NETWORKS

(71) Applicant: SAMSUNG ELECTRONICS CO., LTD., Suwon-si, Gyeonggi-do (KR)

(72) Inventors: Sriganesh RAJENDRAN, Bangalore (IN); Vinay Kumar SHRIVASTAVA, Bangalore (IN)

(21) Appl. No.: 18/553,171

(22) PCT Filed: Apr. 1, 2022
(86) PCT No.: PCT/KR2022/004738

§ 371 Date: Sep. 28, 2023

(30) Foreign Application Priority Data
Apr. 2, 2021 (IN) 202141015741
Mar. 28, 2022 (IN) 202141015741

(51) Int. Cl. H04W 48/18; H04W 48/10; H04W 76/12; H04W 84/04

(52) U.S. Cl. CPC H04W 48/18; H04W 48/10; H04W 76/12; H04W 84/045

(57) ABSTRACT

The disclosure relates to a 5G or 6G communication system for supporting a higher data transmission rate. A method performed by a user equipment (UE), includes: receiving, from at least one stand-alone non-public network base station (SNPN BS), system information block (SIB) including a group ID (GID) at an access stratum (AS) of the UE; reporting each GID per SNPN BS to a non-access stratum (NAS) of the UE, at the AS of the UE; and in case that an RRCSetup message is received from one of the at least one SNPN BS, transmitting an RRCSetupComplete message including a onboarding request.

### TECHNICAL FIELD

Embodiments disclosed herein relate to wireless communication networks, and more particularly to the support of enhancements of non-public networks

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The embodiments herein is to disclose methods and systems for enhancing non-public networks.

### Solution to Problem

The disclosure relates to a 5G or 6G communication system for supporting a higher data transmission rate. A method performed by a user equipment (UE), includes: receiving, from at least one stand-alone non-public network base station (SNPN BS), system information block (SIB) including a group ID (GID) at an access stratum (AS) of the UE; reporting each GID per SNPN BS to a non-access stratum (NAS) of the UE, at the AS of the UE; and in case that an RRCSetup message is received from one of the at least one SNPN BS, transmitting an RRCSetupComplete message including a onboarding request.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates a system diagram for enhancing non-public networks, according to embodiments as disclosed herein;

FIG. 2 illustrates a method through which a UE may gain access to a SNPN that the UE is not subscribed to, according to embodiments as disclosed herein;

FIG. 3 illustrates a method by which the SNPN can handle congestion, according to embodiments as disclosed herein;

FIG. 4 illustrates a method by which the SNPN may notify the UE about a change in the UE's access to the SNPN, according to embodiments as disclosed herein;

FIG. 5 illustrates a method by which the SNPN services an onboarding request from the UE, according to embodiments as disclosed here;

FIG. 6a illustrates an example of signaling flow involving network broadcasting supported GIDs in the SIB1, according to embodiment as disclosed herein;

FIG. 6b illustrates an example of signaling flow involving network broadcasting supported GIDs in the SIB10, according to embodiment as disclosed herein;

FIG. 6c illustrates an example of signaling flow involving network broadcasting supported GIDs in the SIBx, according to embodiment as disclosed herein;

FIG. 6d illustrates an example of signaling flow involving network broadcasting supported GIDs partially in SIB1 and SIBx, according to embodiment as disclosed herein; and

FIG. 7 illustrates an example of signaling flow involved in onboarding procedure, which includes sending of onboarding indication from the UE to the network, according to embodiments as disclosed herein.

### BEST MODE FOR CARRYING OUT THE INVENTION

The disclosure provides the embodiments to provide support for roaming and enabling UE's access to services from SNPNs by adding NPN support for external credential(s) and providing GID information provisioning across different SIBs and in different forms.

The disclosure provides the embodiments to provide support for SNPNs allowing services to UEs, wherein the UE does not have a subscription to the SNPN, but has a subscription from a service provider that is in an agreement with the SNPN.

The disclosure provides embodiments related with a unified access control (UAC) procedure (for eNPN scenario) and other congestion control aspects.

The disclosure provides embodiments related with handling of dynamic and temporary nature of eNPN networks/service providers/GIDs and related handling.

The disclosure provides embodiments related with handling of forbidden SNPN/GID behavior.

The disclosure provides embodiments related with UE capability and network broadcast for eNPN support, impact/behavior for legacy UE/network and related aspects.

According to an embodiment of the disclosure, a method performed by a user equipment (UE), includes: receiving, from at least one stand-alone non-public network base station (SNPN BS), system information block (SIB) including a group ID (GID) at an access stratum (AS) of the UE; reporting each GID per SNPN BS to a non-access stratum (NAS) of the UE, at the AS of the UE; and in case that an RRCSetup message is received from one of the at least one SNPN BS, transmitting an RRCSetupComplete message including a onboarding request.

According to an embodiment of the disclosure, a method performed by a stand-alone non-public network base station (SNPN BS), includes: transmitting, to a user equipment (UE), system information block (SIB) including a group ID (GID); transmitting an RRCSetup message to the UE; and receiving an RRCSetupComplete message including a onboarding request, as a response to the RRCSetup message from the UE, wherein the GID of the SNPN BS is reported from an access stratum (AS) of the UE to a non-access stratum (NAS) of the UE.

According to an embodiment of the disclosure, a UE includes a transceiver; and a processor coupled with the transceiver and configured to: receive, from at least one stand-alone non-public network base station (SNPN BS), system information block (SIB) including a group ID (GID) at an access stratum (AS) of the UE, report each GID per SNPN BS to a non-access stratum (NAS) of the UE, at the AS of the UE, and in case that an RRCSetup message is received from one of the at least one SNPN BS, transmit an RRCSetupComplete message including a onboarding request.

According to an embodiment of the disclosure, a SNPN BS includes a transceiver; and
a processor coupled with the transceiver and configured to: transmit, to a user equipment (UE), system information block (SIB) including a group ID (GID), transmit an RRCSetup message to the UE, and receive an RRCSetupComplete message including a onboarding request, as a response to the RRCSetup message from the UE, wherein the GID of the SNPN BS is reported from an access stratum (AS) of the UE to a non-access stratum (NAS) of the UE.

Accordingly, the embodiments herein provide methods and systems for enhancing non-public networks. A method disclosed herein comprises allowing, by the SNPN, the UE to gain access to services offered by the SNPN, if the UE is subscribed to a home service provider that the SNPN is in agreement with. The method further comprises broadcasting, by the SNPN, a message indicating one or more group identities supported by a plurality of SNPNs. The method further comprises the message broadcasting the one or more group identities supported by the plurality of SNPNs, which includes at least one of a SIB1, a SIB10 or a new SIB (SIBx), wherein the SIBx is one of broadcasted or provided on-demand to the UE. The UE forwards the group identities for network selection (GINs) received in the SIBx with the corresponding SNPN identities to the upper layers comprising the Non-Access Stratum (NAS) layer.

The method disclosed herein for allowing, by the SNPN, the UE to gain access to the services offered by the SNPN, further comprises toggling one or more indicator fields, by a radio base station (gNB), wherein the one or more indicator fields represent at least one of: whether a non-subscribed UE can access the SNPN using the SNPN, whether the SNPN supports onboarding of the non-subscribed UE, and whether overall access control or unified access control (UAC) should be applied.

Another method disclosed herein for notifying a UE about a change in access to a SNPN, comprises providing, by the SNPN, the UE with at least one of: an intimation that is provided in advance to facilitate the UE's performance, an intimation immediately upon a change in the UE's access to the SNPN, a notification conveyed through at least one of downlink control information (DCI), medium access control (MAC) signaling, paging, radio resource control (RRC) signaling, and non-access stratum (NAS) signaling; and a notification that indicates a confirmation or rejection of the UE's access to the SNPN.

Another method disclosed herein for servicing an onboarding request from a UE by a SNPN, comprises determining, by the UE, whether the upper layers comprising the NAS layer provide an onboarding request indication; and sending, by the UE, an onboarding request indication in a radio resource control (RRC) message that requests establishment or resumption of a RRC connection, or a specific indication in an uplink transmission by a medium access control (MAC) control element (CE) in response to determining the upper layers comprising the NAS layer provide an onboarding request indication. The RRC message is either a RRCSetupComplete message or a RRCResumeComplete message.

Accordingly, the embodiments herein disclose a system comprising a UE, a SNPN, and one or more system information blocks. The UE is configured to access the SNPN if at least one of the following occurs: the SNPN belongs to a list of allowed SNPNs that the UE is configured with; the SNPN is in an agreement with one or more services providers that the UE is subscribed to; and the SNPN is in an agreement with the group identities of the one or more service providers that the UE is subscribed to, and wherein the UE is configured with the group identities of the one or more service providers. The UE is also configured to support enhanced non-public networks (eNPN) and access services from the SNPN based on the external credentials or the group identities that the UE is configured with. The SNPN is configured to allow or reject the UE from gaining access to the SNPN. The one or more system information blocks are capable of accommodating at least one of the following: the group identities supported by the SNPN and a human readable network name (HRNN) for each of the group identities and for the SNPN.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

Throughout the disclosure, the expression “at least one of a, b or c” indicates only a, only b, only c, both a and b, both a and c, both b and c, all of a, b, and c, or variations thereof.

Examples of a terminal may include a user equipment (UE), a mobile station (MS), a cellular phone, a smartphone, a computer, a multimedia system capable of performing a communication function, or the like.

In the disclosure, a controller may also be referred to as a processor.

Throughout the specification, a layer (or a layer apparatus) may also be referred to as an entity.

Non-public networks (NPN) or private networks are designed to provide 5G network services to a user defined organization or group of organizations. The 5G NPN may be deployed in an organization's defined premises, such as a campus or a factory.

There are two modes of deployment of NPNs:
Standalone Non-Public Networks (SNPNs)
PLMN Integrated—Non-Public Networks (PNI-NPNs)

SNPNs may be deployed when an entire network is isolated and has no connection with a Public Network (PLMN). In case of a PNI-NPN, the deployment may be done in such a way that the NPN is a means to provide service to a user equipment (UE) belonging to a PLMN.

In the current specifications for NPNs, the concept of roaming is not present in SNPNs. The UEs can access only those SNPNs owned by the subscription providers (also referred to herein as “home service providers”). In order to support the concept of roaming in SNPNs, the enhancements for supporting SNPN along with subscription/credentials owned by an entity separate from the SNPN are proposed.

It may be considered that in order to achieve roaming in SNPNs, few enhancements could be made to the system information being broadcasted, which includes the broadcasting of:
an indicator signaling that the SNPN allows access from a UE belonging to an external authentication entity;
a list of supported Home Service Providers' Group Identities (IDs) with which the SNPN has an agreement with; and
an indicator to signal that the SNPN allows access to the UE not explicitly configured to access the SNPN.

Examples of deployment scenarios for NPNs can include, but are not limited to, factories and campuses. The UEs may be onboarded and provisioned for NPNs.

The embodiments disclosed herein aim to address significant issues such as, but not limited to, the following:
Issues related to broadcasting of Group IDs (GIDs), for example, how can the GIDs be broadcasted?
Issues related to the impact of the SNPN selection due to the broadcasted GIDs
How congestion can be handled in case of roaming in SNPNs?
How forbidden lists can be handled in case of UEs accessing an eNPN?
Whether there is a use of the UE's capability to inform support of eNPN features?

The embodiments herein achieve methods and systems for enhancing non-public networks. Embodiments herein provide support for roaming and enabling UE's access to services from SNPNs by adding NPN support for external credential(s) and providing GID information provisioning across different system information blocks (SIBs) and in different forms. Embodiments herein provide support for SNPNs allowing services to UEs, wherein the UE does not have a subscription to the SNPN, but has a subscription from a service provider which is in an agreement with the SNPN. Embodiments herein disclose a UAC procedure (for eNPN scenario) and other congestion control aspects. Embodiments herein disclose handling of dynamic and temporary nature of eNPN networks/service providers/GIDs and related handling. Embodiments herein disclose handling of forbidden SNPN/GID behavior. Embodiments herein disclose UE capability and network broadcast for eNPN support, impact/behavior for legacy UE/network and related aspects.

GID information provisioning across different SIBs and in different forms (addressing latency and future use case scenarios etc.) and related aspects

One of the enhancements in NPNs is to support roaming and enabling of UE's access to services from Visiting SNPNs (V-SNPNs). To achieve this, enhancement for NPN support for external credentials may be added. The UE may be configured with a list of allowed V-SNPNs it can access, or the V-SNPN may broadcast the identities of home service provider groups with which the V-SNPN is in an agreement with for accessing the SNPN. By using the credentials of any of the home service providers that are a part of the home service provider group(s) that are in agreement with the V-SNPN, the UE may be granted access, by the SNPN, to the SNPN. The UEs may also be configured with a list of Group IDs (GIDs) representing home service provider groups that the UE's subscription provider is a part of. A UE can access a SNPN that supports one of the GIDs that the UE is configured with. The broadcasting of the GIDs, by the SNPN, can reduce the overhead on the SNPN to broadcast all the home service providers that it is in an agreement with. The GIDs may be proposed to follow a similar representation as that of a SNPN identity (PLMN ID (24 bits)+network identification (NID) (44 bits)), hence it can take up 68 bits. The network may have the following options to broadcast the supported GIDs:
broadcasting the GIDs as part of a first system information block (SIB1) (solution 1);
broadcasting the GIDs as part of a tenth system information block (SIB10) (solution 2);
broadcasting the GIDs in the SIB10 and providing an indication in the SIB1 (solution 2a);
broadcasting the GIDs in a new system information block (SIBx) (solution 3); and
broadcasting the GIDs partially in the SIB1 and the rest in the SIBx or the SIB10 (solution 4).

### Solution 1: Broadcasting the GIDs as Part of the SIB1:

In an embodiment herein, the SIB1 can carry the GIDs that are supported by the SNPNs, which can be per SNPN. The supported GIDs can be used for cell access procedure. This can ensure that all information related to cell selection/reselection is broadcasted as part of the SIB1. The advantage of broadcasting the GIDs in the SIB1 is that there may not be any added delay in the cell access process. The GIDs can be added to the SIB1 in the following format, however, it is not limited to this format:
The GIDs can be added as part of the NPN-IdentityInfoList-r16 in the CellAccessRelatedInfo which may be part of the SIB1.
A new information element gid-Lists-r17 may be introduced as part of the NPNIdentityInfo-r16. The gid-Lists-r17 can be a list of GIDs support per SNPN and each of the GID-List-r17 is a list of Gid-r17 which takes the format of snpn-r16 IE.
maxGID-r17 is the maximum number of GIDs that can be per SNPN and/or that can be overall for all SNPNs added in the SIB1 due to size constraints of the SIB1. This can be pre-defined to a specific value which can be, for example, 4 or 8 or 12 or 16, however, without limiting to these examples only.

```
-- ASN1START
-- TAG-NPN-IDENTITYINFOLIST-START
NPN-IdentityInfoList-r16 ::= SEQUENCE (SIZE (1..maxNPN-r16)) OF NPN-
IdentityInfo-r16
NPN-IdentityInfo-r16 ::= SEQUENCE {
npn-IdentityList-r16 SEQUENCE (SIZE (1..maxNPN-r16)) OF NPN-Identity-r16,
trackingAreaCode-r16 TrackingAreaCode,
ranac-r16 RAN-AreaCode OPTIONAL, -- Need R
cellIdentity-r16 CellIdentity,
cellReservedForOperatorUse-r16 ENUMERATED {reserved, notReserved},
iab-Support-r16 ENUMERATED {true} OPTIONAL, -- Need S
...
[
  gid-Lists-r17 SEQUENCE (SIZE(1...maxNPN-r16)) OF GID-List-r17 OPTIONAL,
]
}
GID-List-r17 ::={
Gid-r17 SEQUENCE(SIZE(1..maxGID-r17)) OF snpn-r16 OPTIONAL
}
  gid-Lists-r17:
  The same number of GID-Lists-r17 elements as the number of NPNs in SIB 1 are
  included. The n-th entry of GID-Lists-r17 contains the list of group IDs supported by
  the n-th SNPN of SIB1. The GIDs in the corresponding entry in GID-Lists-r17 is
  absent if there is no GIDs associated with the given SNPN.
-- TAG-NPN-IDENTITYINFOLIST-STOP
-- ASN1STOP
```

### Solution 2: Broadcasting the GIDs as Part of SIB10:

In an embodiment herein, the GIDs are broadcasted as part of the SIB10 which may already be defined as a NPN-specific SIB. The SIB10 can carry the HRNN (Human Readable Network Names) of the NPN IDs which may be used in a manual selection process. As proposed herein, the SIB10 can contain the HRNNs and the supported GIDs of the NPNs listed in the SIB1. Another advantage of broadcasting the supported GIDs in the SIB10 can be that the maximum number of GIDs broadcasted can increase as the size limitation imposed may be much more relaxed for the SIB10 as compared to the SIB1. The UE can decode the SIB10 on a need basis and can decode the SIB10 in case of:
manual network selection as the SIB10 contains the Human Readable Network Name (HRNN) for the network IDs broadcasted in the SIB1
when the broadcasted SNPN ID in the SIB1 isn't part of the UE's home service provider's ID and it is not part of the configured SNPN allowed list.

### Solution 2a: Broadcasting GIDs in SIB10 and Indication in SIB1

In an embodiment herein, the solution for broadcasting the GIDs in the SIB10 can further be enhanced by including an indication in the SIB1 about the GIDs in the SIB10. This can inform the UE about the broadcasting of the GIDs and whether the UE may have to decode the SIB10 to aid in the network selection process.
maxGID-r17 can be the maximum number of GIDs that can be per SNPN and/or that can be overall for all SNPNs.

```
SIB10
SIB10 contains the HRNNs and supported GIDs of the NPNs listed in SIB1.
-- ASN1START
-- TAG-SIB10-START
SIB10-r16 ::= SEQUENCE {
hrnn-List-r16 HRNN-List-r16 OPTIONAL, -- Need R
lateNonCriticalExtension OCTET STRING (CONTAINING eNPN-Access-Parameters)
OPTIONAL,
...
}
HRNN-List-r16 ::= SEQUENCE (SIZE (1..maxNPN-r16)) OF HRNN-r16
HRNN-r16 ::= SEQUENCE {
hrnn-r16 OCTET STRING (SIZE(1.. maxHRNN-Len-r16)) OPTIONAL -- Need R
}
-- Late non-critical extensions:
eNPN-Access-Parameters ::= SEQUENCE {
gid-Lists-r17 SEQUENCE (SIZE(1...maxNPN-r16)) OF GID-List-r17 OPTIONAL,
nonCriticalExtension SEQUENCE { } OPTIONAL
}
GID-List-r17 ::={
Gid-r17 SEQUENCE(SIZE(1..maxGID-r17)) OF snpn-r16 OPTIONAL
}
-- TAG-SIB10-STOP
-- ASN1STOP
  gid-Lists-r17:
  The same number of GID-Lists-r17 elements as the number of NPNs in SIB 1
  are included. The n-th entry of GID-Lists-r17 contains the list of group IDs
  supported by the n-th NPN of SIB1. The GIDs in the corresponding entry in
  GID-Lists-r17 is absent if there is no GIDs associated with the given NPN.
```

### Solution 3: Broadcasting GIDs in a New SIB;

In an embodiment, similar to sending the GIDs in the SIB10, another solution can be having the GIDs broadcasted as part of a new SIB (SIBx). Broadcasting the GIDs in the SIBx can have the advantage that if this SIBx is scheduled as part of the scheduling information (SI) in SIB1, this can implicitly convey to the UE that the GIDs are being broadcasted and that they may need to be acquired by the UE while performing the network selection. Further, embodiments herein also provide provision(s) that can control the periodicity of the SIBx to suitably cater to the latency requirements of the GIDs that are being provided.

In an embodiment herein, the SIBx introduced can also be made as an on-demand SIB, which can aid in implicitly informing the UEs that the GIDs are supported by the SNPN and UE can acquire it by performing System Information Request procedure. It is to be noted that the terms GIDs and GIN may be used interchangeably.

| | |
|---|---|
| SIB-TypeInfo ::= | SEQUENCE { |
| type | ENUMERATED {sibType2, sibType3, |

sibType4, sibType5, sibType6, sibType7, sibType8, sibType9,

sibType10-v1610,

sibType11-v1610, sibType12-v1610, sibType13-v1610, sibType14-v1610,

sibTypeX, spare2,

spare1,... },

| | |
|---|---|
| valueTag | INTEGER (0..31) |

OPTIONAL, -- Cond SIB-TYPE

| | |
|---|---|
| areaScope | ENUMERATED {true} |

OPTIONAL -- Need S
}

The network can configure a lower periodicity to the SIBx so that there is lesser delay in the acquisition of the SIBx. The UE may interpret the presence of the scheduling information of the SIBx in the schedulingInfoList in the SIB1 as an indication that the SNPN supports group identities for network selection (GINs). Upon acquiring the SIBx, the list of SNPN IDs along with their GIDs may be forwarded to a higher layer (e.g. Non-Access Stratum or NAS layer) of the UE where the network selection takes place by considering the obtained information.

SIBx
SIBx contains the supported GIDs of the NPNs listed in SIB1.
-- ASN1START
-- TAG-SIBx-START
SIBx-r17 ::= SEQUENCE {
gid-Lists-r17 SEQUENCE (SIZE(1...maxNPN-r16)) OF GID-List-r17
OPTIONAL,
nonCriticalExtension SEQUENCE { } OPTIONAL
}
GID-List-r17 ::={
Gid-r17 SEQUENCE(SIZE(1..maxGID-r17)) OF snpn-r16 OPTIONAL
}
-- TAG-SIBx-STOP
-- ASN1STOP

In another embodiment herein, the SIBx introduced can also be sent as one or more segments of the SIB message if the size of the concerned SIB message is larger than the maximum allowed size of system information message.

```
SIBx
SIBx contains the supported GIDs of the NPNs listed in SIB1.
-- ASN1START
-- TAG-SIBx-START
SIBx-r17 ::= SEQUENCE {
sibMessageSegmentNumber INTEGER (0..63),
segmentType ENUMERATED (notLastSegment, lastSegment),
sibMessageSegment OCTET STRING,
nonCriticalExtension SEQUENCE { } OPTIONAL
}
SIBx-IEs-r17 ::= SEQUENCE {
gid-Lists-r17 SEQUENCE (SIZE(1...maxNPN-r16)) OF GID-List-r17 OPTIONAL,
    lateNonCriticalExtension OCTET STRING
OPTIONAL,
    ...
}
GID-List-r17 ::={
Gid-r17 SEQUENCE(SIZE(1..maxGID-r17)) OF snpn-r16 OPTIONAL
}
-- TAG-SIBx-STOP
-- ASN1STOP
  sibMessageSegment:
  Includes a segment of the encoded SIBx-IEs (e.g. consisting of GID List)
  sibMessageSegmentNumber:
  Identifies the sequence number of a segment of SIBx-IEs (e.g. consisting of
  GID List).A segment number of 0 corresponds to the first segment, a segment
  number of 1 corresponds to the second segment, and so on.
  segmentType:
  Indicates whether the included segment is the last segment or not
```

Upon receiving the SIBx, the UE may:
a. if the UE has stored at least one segment of the SIBx and the value tag of the SIBx has changed since a previous segment was stored, then discard all stored segments. Otherwise, the UE may store the segment;
b. if all segments have been received, then assemble SIBx-IEs from the received segments.

The UE may discard any stored segments for the SIBx if the complete SIBx has not been assembled within a period of 3 hours. The UE may discard any stored segments for SIBx upon cell selection/re-selection.

### Solution 4: Broadcasting GIDs Partially in SIB1 and Partially in New SIB or SIB10

In an embodiment herein, as another solution to the problem of broadcasting the GIDs, the SIB1 can accommodate few of the GIDs based on at least one of the following criteria, but not limiting to, the GIDs encountering highest traffic, the latency requirements of the GIDs or services, the priority of the GIDs or services, the service level agreements, and the limit of SIB1 to accommodate the GIDs.

If the number of the GIDs to be broadcasted are more than what the SIB1 can accommodate, the network may accommodate and broadcast the remaining GIDs as part of the SIB10. The SIB1 can include an indication to notify the existence of the remaining GIDs in the other SIBs.

This solution can have the advantage that at least the UEs having a subscription to the GIDs that are being broadcasted in the SIB1 can obtain the data for network selection soon. Also, the other UEs may get an indication regarding whether the UEs have to decode the other SIBs to complete the network selection process.

Another advantage of this solution can be that the maximum number of GIDs that can be broadcasted is not constrained as in the case of using only the SIB1 to broadcast the GIDS.

In another embodiment, the UE which is trying to access the SNPN using external credential and/or during onboarding process, may:
acquire the SIB1 and receive a list of SNPN IDs broadcasted by the network;
acquire the at least one of SIBx/SIB1/SIB10 which contains the corresponding GID list, if the si-schedulingInfo in SIB1 has the schedule of the SIBx;
perform an on demand system information acquisition procedure if the broadcast status for the SIBx/SIB10 is set to “not broadcasting” in the SIB1; or
indicate to higher layer the acquired SNPN IDs and the corresponding GIDs for network selection procedure.

### Enhancement to Manual Selection Procedure Based on GID:

The HRNN of the NPN ID may be broadcasted by the network in the SIB10 and may be presented to the user during the manual selection of the SNPN. This can aid the user in selecting an appropriate network to access.

With the enhancements proposed for NPNs, a user can access networks based on the broadcasted list of supported GIDs of the service providers.

In cases of accessing the SNPN using external credentials and when the SNPN ID is not part of the configured list of allowed SNPN IDs, the selection of the SNPN may not be based on the ID of the network but rather may be based on the supported GIDS of the network. Thus, during manual selection of the network, it may be appropriate to present the user with the HRNN of the GIDs along with the HRNN of the NPN ID. The user can make a better choice when presented with the HRNN of the GIDs as it is the ID related to the user's own subscription provider, compared to when the user is only given the HRNNs of the visiting networks.

In an embodiment herein, as a solution to enhance the manual network selection process, the SIB10 may be enhanced to accommodate the HRNN of the GIDs being broadcasted by the network.

In another embodiment, a different SIB or the SIBx may be utilized to accommodate the HRNN of the GIDs being broadcasted by the network.

In the HRNN-List_r17, the number of HRNN elements that are included can be the same as the number of GIDs in the SIBx. The n-th entry of the HRNN-List can contain the HRNN of the n-th GID of the SIBx. The HRNN in the corresponding entry in the HRNN-List may be absent if there is no HRNN associated with the given GID.

The HRNN of the GID can use the same or different structure/format of the HRNN-r16 which may be used represent the HRNN of the NPN IDs.

```
SIB10
SIB10 contains the HRNNs and supported GIDs of the NPNs listed in SIB1.
-- ASN1START
-- TAG-SIB10-START
SIB10-r16 ::= SEQUENCE {
hrnn-List-r16 HRNN-List-r16 OPTIONAL, -- Need R
lateNonCriticalExtension OCTET STRING OPTIONAL,
...
[
hrnn-List-r17 HRNN-List-r17 OPTIONAL, -- Need R
]
}
HRNN-List-r16 ::= SEQUENCE (SIZE (1..maxNPN-r16)) OF HRNN-r16
HRNN-List-r17 ::= SEQUENCE (SIZE (1..maxGID-r17)) OF HRNN-r16
HRNN-r16 ::= SEQUENCE {
hrnn-r16 OCTET STRING (SIZE(1.. maxHIRNN-Len-r16)) OPTIONAL -- Need R
}
-- TAG-SIB10-STOP
-- ASN1STOP
  HRNN-List-r17:
  The same amount of HRNN elements as the number of GIDs in SIBx are included. The
  n-th entry of HRNN-List contains the human readable network name of the n-th GID of
  SIBx. The hrnn in the corresponding entry in HRNN-List is absent if there is no HRNN
  associated with the given GID.
```

Upon acquiring the SIB10, the HRNN of the NPN ID and the HRNN of the GIDs may be forwarded to the higher layer.

During the manual selection process, the UE may indicate to the user, a list of available SNPN IDs which may have an entry in a “list of subscriber data” or in a “preferred SNPN list,” or a list of available SNPN IDs may broadcast the GIDs and have an entry in a “preferred GID list”. For each of the indicated SNPNs, the UE may forward the HRNN associated with the SNPN ID, along with the HRNNs of the list of broadcasted GIDs for that SNPN ID.

GID Usage for SNPN Selection (and/or Reselection, Mobility Etc.) and Other Aspects:

The enhancements to the NPN can bring in the support for the SNPNs allowing services to UEs not having a subscription to the SNPN, and instead having a subscription from a service provider that is in an agreement with the SNPN. This enhancement could have an impact on the SNPN selection, as traditionally, the UE could only access those SNPNs that the UE was subscribed to.

To support the enhancements, the UEs may be pre-configured by the subscription provider as part of a provisioning procedure, with:
a list of preferred SNPNs.
a list of Group IDs of which the UE's service provider is a part of.

The Access Stratum (AS) of the UE may report to the Non Access Stratum (NAS) of the available/applicable SNPNs along with the associated Group IDs broadcasted. The SNPN selection process can happen based on
matching of the SNPN to home service provider's ID.
matching of broadcasted SNPN ID with the SNPN ID in a preferred SNPN list.
matching of broadcasted GIDs with the list of configured GIDs.

The enhanced SNPNs may also be capable of supporting onboarding of the UEs and remotely provisioning them with 3GPP credentials for future access. Such SNPNs may broadcast an indicator that it supports onboarding. Along with the indicator, the SNPN can also broadcast the list of service providers whose UEs it can onboard.

In cases where the UE is trying to access the SNPN for onboarding purpose but is not configured with a preferred network list based on which the SNPN selection can happen, the UE can make use of the GID(s) being broadcasted to select the SNPN for onboarding purpose even if the SNPN is not part of the configured list.

UAC Procedure (for eNPN Scenario) and Other Congestion Control Aspects.

In case of enhanced NPNs, the network could be accessed by UEs not only belonging to the SNPN, but also by the UEs, which are roaming from other SPs. This could result in congestion in SNPN and thus may require a mechanism to alleviate this congestion.

One of the available frameworks for congestion control is unified access control (UAC). UAC, applied by the SNPN, can provide a granular control over the access restriction for a UE based on the triggering events and services requested by the UE.

Embodiments herein disclose a new access category and/or a range/set of access categories, for example “Access category 11”, but not limiting to this option, for handling the congestion arising due to access of UEs with third-party credentials.

The new access category and/or categories introduced, by the SNPN, can be used to restrict all the UEs accessing the network using external credentials, and this addition may not impact the UAC framework.

In another embodiment of the invention, a new access restriction indication can be signaled by the SNPN as part of the SIB1. This indication can determine whether to selectively apply the UAC barring parameters, present in the SIB1, to the UEs trying to access the network with external credentials or for onboarding. If this indication is absent, the barring parameters may be applied uniformly to all the UEs in that SNPN and/or GID.

This method may be employed to alleviate congestion in the network by allowing only those UEs that belong to that network to be able to access the network.

SIB1-v1630-IEs ::= SEQUENCE {
uac-BarringInfo-v1630 SEQUENCE {
uac-AC1-SelectAssistInfo-r16 SEQUENCE (SIZE (2..maxPLMN)) OF
UAC-AC1-SelectAssistInfo-r16
} OPTIONAL, -- Need R
nonCriticalExtension SIB1-v17-IEs OPTIONAL
}
SIB1-v17-IEs ::= SEQUENCE {
uac-SNPN-BarringInfo-v17 choice {
snpnCommon-r17 UAC-SelectInfo-r17,
individualSNPNList-r17 SEQUENCE (SIZE (1..maxPLMN)) OF
UAC-SelectInfo-r17
}
nonCriticalExtension SEQUENCE { } OPTIONAL
}
UAC-SelectInfo-r17 ENUMERATED {a, b}

Other methods of congestion handling, by the SNPN, can be:
redirection of the UEs to neighboring cells: This can be achieved by the network by sending a radio resource control release (RRCRelease) message with redirection information.
redirection of the UEs to other SNPNs which are in an agreement with the home service provider of the UE.
rejection of the access request by the UE with a new cause “congestion handling” and a congestion timer after which the UE can try to access the network again.
release to Idle state: This can be achieved by the network sending a RRCRelease Message to release the UE to Idle state.
release to Inactive state: This can be achieved by the network sending a RRCRelease with SuspendConfig Message to release the UE to Inactive state.
terminate/remove lower priority service(s) and/or GIDs.

In another embodiment, the congestion control is performed by the gNB by toggling between a set/reset of one or combination of the broadcasted indicator bit or field e.g. an indicator for access using credentials from a separate entity is supported, indicator for whether SNPN allows registration attempts from UEs, indicator for whether onboarding is supported.

In another embodiment, a combination of the set/reset of the indicator and/or UAC based access control may be utilized on the same cell/SNPN/network

In another embodiment, the set/reset of indicator(s) may be used for overall access control i.e. complete barring, whereas the UAC based control may be used for selective access for access categories and/or services.

### Dynamic and Temporary Nature of Networks and Related Handling and Other Aspects

With the introduction of priority access licenses (PALs), the requirements and service aspects of temporary networks could evolve. And in such use case and scenarios, the service level agreements (SLAs) between the service providers and SNPNs could change frequently and also the SNPNs can be spawned/released temporarily. In such cases, the GIDs/service providers being supported by that SNPN can also change frequently. Thus, the network selection information at the UE might not be always up-to-date. An example of such a scenario can be when a sports event or concert is to take place in an area having no pre-existing facilities or infrastructure. Another example can be when schools need to relocate due to a natural disaster or an instruction regarding that during a ‘field trip.’ Another example can be when hospitals need to expand in a crisis situation. Workers may need to use temporary facilities or gather for a conference. Industrial facilities may require network communication only on demand, for example to increase surveillance during construction of a sensitive facility where normal physical access restrictions are not in place. A ‘Mall’ could refer to a periodic trade fair or market. Some transit hubs may require additional network services, e.g., due to extreme weather or other crisis in which many travelers are stranded in the port or station.

In an embodiment, to address the dynamic and/or temporary nature of the SNPN/service provider/GIDs, a provision may be provided, by the SNPN, to inform the UEs about the change. This can also be a pre-intimation which may be provided in advance to facilitate the UE performance (e.g. seamless migration) or an intimation that is sent immediately upon an event occurring. The provision can include the use of at least one of change notification conveyed through Downlink control information (DCI), medium access control (MAC) signaling (MAC Control Element, i.e. MAC CE), paging (e.g. change indication or system information change indication), or RRC signaling and NAS signaling.

In an embodiment, when the UE is not updated in time about the dynamic changes, the UE may be informed about the rejection of the request as the relevant SNPN/GID/service provider may not be fulfilled. For this purpose, a confirmation and/or reject notification can be added towards the UE by the network.

### Forbidden SNPN/GID Behavior and Other Aspects:

Forbidden SNPN lists may be used to prevent a UE from repeatedly accessing the network when the network had rejected the access by the UE. In the current specification UE may maintain two lists:
a temporarily forbidden SNPNs list.
a permanently forbidden SNPNs list.

The SNPNs may be added to the list based on the rejection cause sent by network. If the networks reject the UE with, for example, cause #74 (“Temporarily not authorized to access this SNPN”), that SNPN may get added to the temporarily forbidden SNPNs list. If the networks reject the UE with, for example, cause #75 (“Permanently not authorized to access this SNPN”), that SNPN may get added to the permanently forbidden SNPNs list. The forbidden SNPN lists may be valid until the timer T3245 expires. When the timer T3245 expires, the lists may be erased. The duration of for which the timer 3245 runs can be chosen at random between 12 h and 24 h.

In case of enhanced NPNs, there can arise several scenarios in which the UEs get rejected upon access such as, but not limited to:
the case where the UE's available information for network selection is out of date;
the case where the UE tries to access a SNPN which is not explicitly configured and this access results in a rejection; and
the case where the UE tries to access a SNPN and/or GID which is not explicitly configured and this access results in a rejection.

In order to accommodate such scenarios and to prevent the UE from trying to repeatedly access the particular SNPN, the UE and/or GID can be added to the forbidden SNPN list.

Currently, the timer value for the timer T3245 can be as long as a value, between 12 hrs-24 hrs, chosen at random. But with the new use cases and future ones envisioned for NPNs where the nature of the network can be temporary or the SLAs between the NPNs and the service providers are dynamic, the validity of the list can change frequently.

### Solution to Provide a Better Framework for Handling of the Forbidden SNPN List:

The UE may maintain a new list called “provisionally forbidden SNPNs list”. During the SNPN selection, if the SNPN belongs to the temporarily forbidden SNPNs list, the permanently forbidden SNPNs list, the provisionally forbidden SNPNs list, or is an invalid entry in a “subscription data list,” the SNPN may not be considered as a suitable SNPN. If the initial registration is not accepted by the network and is rejected with a newly introduced 5GMM cause value “#x—Provisionally not authorized for this SNPN”, the UE may add the SNPN to the provisionally forbidden SNPNs list along with a message indicating the same. A new timer T3xxx can be introduced to maintain the validity of the entries in the provisionally forbidden SNPNs list. The value of the timer T3xxx may be configured by the network in the REGISTRATION REJECT message when the cause value is “#x—Provisionally not authorized for this SNPN.” The network configured timers T3xxx can be configured based on the information available at the network side about the frequency in which the support for service providers change, but it is not limited to this criterion alone. The UE can maintain the timer T3xxx per SNPN entry in the provisionally forbidden SNPNs list, and upon expiry of the timer, the entry may be removed from the list, and the UE may attempt to access the SNPN again. Upon updating the provisionally forbidden SNPNs list, the UE can use the SNPN entry in the next SNPN selection attempt.

In another embodiment, the UE may maintain the list and perform the operation as described previously in the case of forbidden SNPN and GIDs and/or in the case of forbidden GIDs

Further Enhancements e.g. PALS Network

In an embodiment, the eNPN network can also be utilized to facilitate localized service delivery and/or supporting dense local networks wherein a large number of users can be provided services. A good example set of such scenarios and use cases can include a stadium, a community, public place, a mall, industry, school, hospital. In certain scenarios where the user density is quite high, there may be a limitation in terms of the active number of connections or users supported and/or admission control overload etc. Certain new approaches may be required to address such concerns which can include:
supporting certain services e.g., unicast and/or multicast and/or broadcast services in Idle and/or Inactive mode.
dynamic allocation and switching of Bandwidth Parts (BWPs) and/or Frequency resources for different SNPNs/service providers.
migration/redirection/mobility of UEs or services to different SNPNs/service providers to load balance.
switching of UEs or services across unicast and/or multicast and/or broadcast delivery modes.
addition of new carriers and/or serving cells and/or nodes.
prioritization among users/services in accordance with the priority, access class, access category and termination/release of the lower priority/redundant connections and/or resources.

UE capability and NW broadcast for eNPN support, impact/behavior for legacy UE/network and related aspects

The information that the UE is capable of supporting enhanced NPN features can be notified to the network via the UE capability message. The UE capability information indicating the support for eNPN features can be made use of by the network during the cases such as to selectively redirect UEs, supporting the eNPN features, to another SNPN that also supports the same service provider's credentials. This capability information may be necessary to perform the redirection, as the UEs which do not support the eNPN features can only access the SNPNs that the UE is subscribed to.

In an embodiment, eNPN-Features-r17 can also be a field (a bit or bit-string or bitmap) wherein each bit may indicate support for one or more eNPN features. Some of these bits can also be reserved, and potentially be utilized in future. In another embodiment, the eNPN-Features-r17 can be a field (or a set of fields) that may indicate support or no support for eNPN-Feature (or as set of eNPN-Features).

```
UE-NR-Capability-v17 ::= SEQUENCE [
eNPN-Features-r17 ENUMERATED {supported} OPTIONAL,
nonCriticalExtension SEQUENCE { } OPTIONAL
}
  eNPN-Features-r17:
  This field is used to indicate the capability of UE to support eNPN
  features of Rel17
```

In another embodiment, the UE may indicate the support of eNPN feature and/or its capability to be configured with the GIDs and the preferred SNPN list for onboarding and/or external credential access purpose through NAS Capability signaling,

In an embodiment, if the UE indicates its capability to support eNPN features via access stratum (AS) and/or NAS capability signaling, the network may configure the UE with network selection assistance information, such as list of GIDs and/or preferred SNPN list for gaining access to the external credential holder through the SNPN and/or for onboarding purpose through SNPN, using one of the existing provisioning methods such as Steering of Roaming procedure or UE parameter Update procedure.

In an embodiment, a new 5G Mobility Management (5GMM) capability information element (IE) may be introduced to indicate the UE's support of eNPN features. The following is an example depiction of the introduced IE.

| 8 | 7 | 6 | 5 | 4 | 3 | 2 | 1 | |
|---|---|---|---|---|---|---|---|---|
| 5GMM capability IEI | | | | | | | | octet 1 |
| Length of 5GMM capability contents | | | | | | | | octet 2 |
| SGC | 5G-IPHC- | N3 data | 5G-CP | RestrictEC | LPP | HO attach | S1 | octet 3 |
| | CP CIoT | | CIoT | | | | mode | |
| RACS | NSSAA | 5G-LCS | V2XCNPC5 | V2XCEPC5 | V2X | 5G-UP CloT | 5GSRVCC | octet 4* |
| ProSe- | ProSe-dc | ProSe-dd | ER-NSSAI | 5G-EHC- | multipleUP | WUSA | CAG | octet 5* |
| 12relay | | | | CP CIoT | | | | |
| PR | RPR | PIV | NCR | NR-PSSI | ProSe-13rmt | ProSe- | ProSe- | octet 6* |
| | | | | | | 12rmt | 13relay | |
| spare | spare | spare | spare | spare | eNPN | MINT | NSSRG | octet 7* |
| 0 | 0 | 0 | 0 | 0 | 0 | 0 | 0 | octet |

| | |
|---|---|
| Spare | 8*-15* |

For example, the octet 7 and bit 3 in the above example depiction can indicate the UE's capability to support enhancement to Non Public Networks (eNPN) features, including capability to be configured with GIDs for network selection. If the bit 3 indicates a value 0, it may mean that eNPN features may not be supported by the UE. If the bit 3 indicates a value of 1, it may mean that the UE is capable of supporting eNPN features. The bits 3-8 in the octet 7 and the bits in the octets 8 to 15 may be spare, and can be coded as zero if the respective octet is included in the IE.

In an embodiment, the UE during the Initial NAS Registration procedure, if the UE supports eNPN feature, then the UE shall set the eNPN capability bit to “eNPN supported” in the 5GMM capability IE of the REGISTRATION REQUEST message

### AMF Selection During SNPN Onboarding Scenario:

A SNPN can act both as an onboarding network as well as a subscription-offering network, and there can be different access and mobility management functions (AMFs) for onboarding and normal service of the SNPN. Thus, in order to aid in selecting the appropriate AMF, the UE may send the onboarding request indication to the network.

An onboarding SNPN can support onboarding of UEs from multiple service providers or groups of service providers. In such cases, there can be deployment scenarios where there are individual onboarding AMFs for each of the supported service providers. In such cases, there can arise an issue of how the onboarding SNPN selects the appropriate AMF for onboarding.

In an embodiment as a solution, the “onboarding request” indication can be sent as an establishment cause in the RRCSetupRequest or as a resume cause in the RRCResumeRequest message or a specific indication in the msg3 by a MAC CE.

In an embodiment, the network may configure a timer and/or the UE may maintain a timer Txxx to track the onboarding request procedure. In case, it is unsuccessful e.g. transmission is failed, the UE may attempt again until the timer expires or the transmission is a success. The timer Txxx may be stopped on success or when an explicit rejection is received from network. On the timer expiry, the AS can inform the higher layer (e.g. NAS).

-- ASN1START
-- TAG-RRCSETUPREQUEST-START
RRCSetupRequest ::= SEQUENCE {
rrcSetupRequest RRCSetupRequest-IEs
}
RRCSetupRequest-IEs ::= SEQUENCE {
ue-Identity InitialUE-Identity,
establishmentCause EstablishmentCause,
spare BIT STRING (SIZE (1))
}
InitialUE-Identity ::= CHOICE {
ng-5G-S-TMSI-Part1 BIT STRING (SIZE (39)),
random Value BIT STRING (SIZE (39))
}
EstablishmentCause ::= ENUMERATED {
emergency, highPriorityAccess, mt-Access, mo-Signalling,
mo-Data, mo-VoiceCall, mo-VideoCall, mo-SMS, mps-Priority Access,
mcs-Priority Access,
onboardingRequestIndication, spare5, spare4, spare3, spare2, spare1}
-- TAG-RRCSETUPREQUEST-STOP
-- ASN1STOP

In an embodiment herein, the “Onboarding request” indication, which also aids in AMF selection, can be sent in msg5 (e.g. RRCSetupComplete message) since the next generation radio access network (NG-RAN) may perform the AMF selection after the reception of msg5.

In an embodiment, a method disclosed herein for servicing an onboarding request from the UE by the SNPN, comprises determining, by the UE, whether the upper layers comprising the NAS layer provide an onboarding request indication; and sending, by the UE, an onboarding request indication in a radio resource control (RRC) message that requests establishment or resumption of a RRC connection, or a specific indication in an uplink transmission by a medium access control (MAC) control element (CE) in response to determining the upper layers comprising the NAS layer provide an onboarding request indication. The RRC message can be either a RRCSetupComplete message or a RRCResumeComplete message.

In yet another embodiment, a solution for aiding the AMF selection by the SNPN, can be to send in the service provider ID or the GID which the service provider is associated with during the connection setup and/or connection resume process. This information can be used by the network for performing the AMF selection. This service provider ID/GID can be sent as part of either a RRCSetupComplete message or a RRCResumeComplete message that may contain other parameters being used for AMF selection.

In another embodiment, a combination of Msg3 and Msg5 approaches can be used e.g. “onboarding request” indication may be sent through msg3 where the service provider ID/GID is sent through msg5.

In another embodiment, Msg3 and/or Msg5 approaches may be used based on the Idle or Inactive state of the UE e.g. Msg3 may be used for Inactive mode and Msg5 for the Idle mode and/or other combinations of these messages and/or modes.

```
-- ASN1START
-- TAG-RRCSETUPCOMPLETE-START
RRCSetupComplete ::= SEQUENCE {
rrc-TransactionIdentifier RRC-TransactionIdentifier,
criticalExtensions CHOICE {
rrcSetupComplete RRCSetupComplete-IEs,
criticalExtensionsFuture SEQUENCE { }
}
...
RRCSetupComplete-v17-IEs ::= SEQUENCE {
onboardingRequest-r17 ENUMERATED {true} OPTIONAL,
gId-Index-r17 INTEGER (1..maxGId) OPTIONAL,
nonCriticalExtension SEQUENCE{ } OPTIONAL
}
-- TAG-RRCSETUPCOMPLETE-STOP
-- ASN1STOP
  onboardingRequest-r17:
  Indication that the connection establishment is an onboarding request.
  This information is used at network side for AMF selection.
  gId-Index-r17 :
  This related to Subscription Providers' Group Id for which the
  onboarding process is initiated. The value is the index of the GID
  broadcasted as part of SIBx for the selected SNPN. .
```

In an embodiment, if the UE NAS indicates that the connection request is for onboarding purpose, the UE AS may set the OnboardingRequest-r17 field as true in the RRCSetupComplete message (message 5 or msg5).

In an embodiment, the AMF may indicate its support for onboarding in at least one of the following: NG Application Protocol (NGAP) messages, NG SETUP message, and AMF CONFIGURATION UPDATE message.

In another embodiment, the network, when receiving the RRCSetupComplete message from the UE, may select the AMF to send the INITIAL UE MESSAGE based on at least one of the following, but not limited to, parameters from UE: Selected Network Slice Selection Assistance Information (S-NSSAI), Selected SNPN ID, Onboarding Indicator, and AMF's support for Onboarding procedure.

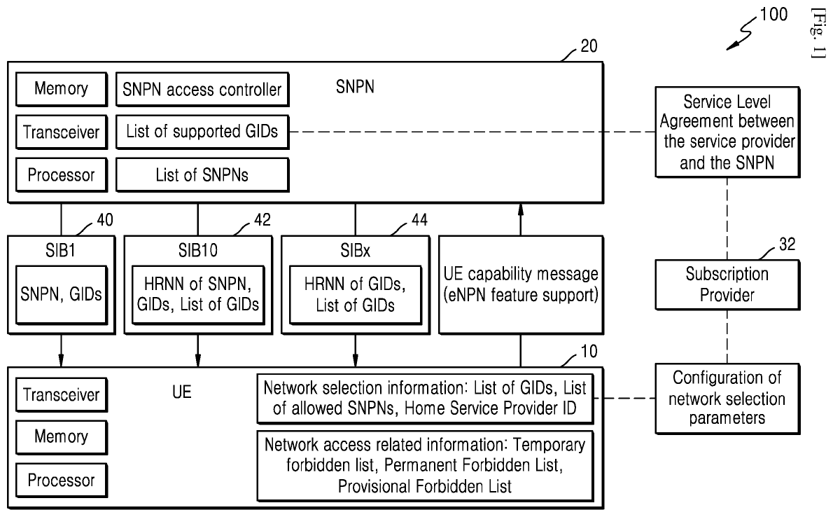

Referring now to the drawings, and more particularly to FIGS. 1 through 7, where similar reference characters denote corresponding features consistently throughout the figures, there are shown example embodiments.

FIG. 1 illustrates a system 100 for enhancing non-public networks (NPN).

Referring to the FIG. 1, the UE 10 may include a processor, a transceiver and a memory. However, all of the illustrated components are not essential. The UE 10 may be implemented by more or less components than those illustrated in FIG. 1. In addition, the processor and the transceiver and the memory may be implemented as a single chip according to another embodiment.

The aforementioned components will now be described in detail.

The processor may include one or more processors or other processing devices that control the proposed function, process, and/or method. Operation of the UE in accordance with the embodiment of the disclosure may be implemented by the processor.

The transceiver may include a RF transmitter for up-converting and amplifying a transmitted signal, and a RF receiver for down-converting a frequency of a received signal. However, according to another embodiment, the transceiver may be implemented by more or less components than those illustrated in components.

The transceiver may be connected to the processor and transmit and/or receive a signal. The signal may include control information and data. In addition, the transceiver may receive the signal through a wireless channel and output the signal to the processor. The transceiver may transmit a signal output from the processor through the wireless channel.

The memory may store the control information or the data included in a signal obtained by the UE 10. The memory may be connected to the processor and store at least one instruction or a protocol or a parameter for the proposed function, process, and/or method. The memory may include read-only memory (ROM) and/or random access memory (RAM) and/or hard disk and/or CD-ROM and/or DVD and/or other storage devices.

The SNPN 20 may include a processor, a transceiver and a memory. However, all of the illustrated components are not essential. The SNPN 20 may be implemented by more or less components than those illustrated in FIG. 1. In addition, the processor and the transceiver and the memory may be implemented as a single chip according to another embodiment.

The aforementioned components will now be described in detail.

The processor may include one or more processors or other processing devices that control the proposed function, process, and/or method. Operation of the SNPN in accordance with the embodiment of the disclosure may be implemented by the processor.

The transceiver may include a RF transmitter for up-converting and amplifying a transmitted signal, and a RF receiver for down-converting a frequency of a received signal. However, according to another embodiment, the transceiver may be implemented by more or less components than those illustrated in components.

The transceiver may be connected to the processor and transmit and/or receive a signal. The signal may include control information and data. In addition, the transceiver may receive the signal through a wireless channel and output the signal to the processor. The transceiver may transmit a signal output from the processor through the wireless channel.

The memory may store the control information or the data included in a signal obtained by the SNPN 20. The memory may be connected to the processor and store at least one instruction or a protocol or a parameter for the proposed function, process, and/or method. The memory may include read-only memory (ROM) and/or random access memory (RAM) and/or hard disk and/or CD-ROM and/or DVD and/or other storage devices.

It is to be noted that the terms SNPN and SNPN base station (BS) may be used interchangeably.

The UE 10 may be able to access the SNPN 20 despite not being subscribed to the SNPN 20, by virtue of having network selection information configured by a subscription provider 12 (also referred to herein as “service provider”) that may belong to a subscription provider group (also referred to herein as “home service provider group”) that is in an agreement with the SNPN 20. The UE 10 may be configured with a list of allowed SNPN indicating the SNPN 20 that the UE 10 may access. The UE 10 may also be configured with a list of group IDs that the UE's subscription provider 12 belongs to, and the UE 10 may access the SNPN 20 if the SNPN 20 supports the one or more group IDs (GIDs) of the subscription provider groups 30 that the UE's subscription provider 12 belongs to.

The UE 10 may also transmit a UE capability message that indicates to the SNPN 20 that the UE 10 is capable of supporting enhanced NPN (eNPN) features. The UE 10 may also be configured with a plurality of lists that may classify a plurality of SNPNs as ones that the UE 10 is temporarily forbidden, permanently forbidden, or provisionally forbidden from accessing.

The system 100 may further comprise a plurality of system information blocks which may include information such as, but not limited to, the GIDs supported by the SNPN 20, the HRNN of the GIDs supported by the SNPN 20, or the HRNN of the SNPN 20. The SIB1 40 may broadcast the GIDs supported by the SNPN 20. An advantage with broadcasting the GIDs as part of the SIB1 40 can be that there may not be any added delay in the cell access process. The SIB10 42 may, in addition to broadcasting the GIDs supported by the SNPN 20, also carry the HRNN of the SNPN 20 and the GIDS supported by the SNPN 20. An advantage with broadcasting the GIDs as part of the SIB10 42 compared to the SIB1 40 can be that the SIB10 42 is capable of broadcasting a larger number of GIDs supported by the SNPN 20. The SIBx 44 may also broadcast the GIDs supported by the SNPN 20, and may also carry the HRNN of the GIDs supported by the SNPN 20. An advantage with broadcasting the GIDs as part of the SIBx 44 can be that if the SIBx 44 is scheduled as part of the scheduling information in the SIB1 40, then this may implicitly convey to the UE 10 that the GIDs are being broadcasted and that they may need to be treated while performing network selection. Upon the UE 10 acquiring the SIB10 42 or the SIBx 42, the information within the SIB10 42 or the SIBx 44 may be forwarded to a higher layer, an example of which is non-access stratum (NAS).

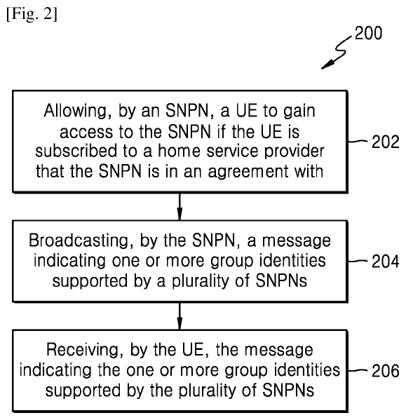

FIG. 2 illustrates a method 200 by which the UE 10 may access the SNPN 20 despite not being subscribed to the SNPN 20. At step 202, the UE 10 may access the SNPN 20 if the UE's 10 subscription provider is in an agreement with the SNPN 20. At step 204, the SNPN 20 may broadcast a message indicating one or more GIDs supported by a plurality of SNPNs 20. At step 206, the UE 10 may receive the broadcasted message from the SNPN 20.

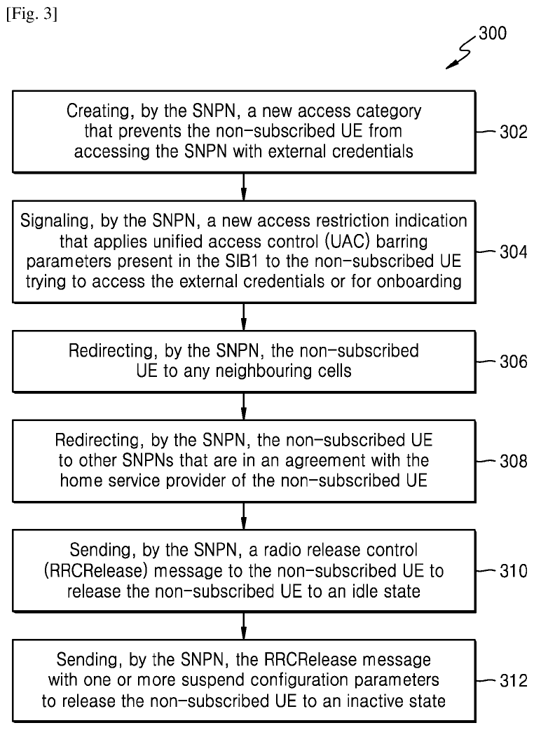

FIG. 3 illustrates a method 300 by which the SNPN 20 controls congestion. At step 302, the SNPN 20 may create a new access category that prevents a non-subscribed UE 10 from accessing the SNPN 20 with external credentials. It is to be noted that the term “non-subscribed UE” refers to the UE 10 that are not subscribed to the SNPN 20. At step 304, the SNPN 20 may signal a new access restriction indication that applies unified access control (UAC) barring parameters present in the SIB1 40 to the non-subscribed UE 10 trying to access the external credentials for onboarding. At step 306, the SNPN 20 may redirect the non-subscribed UE 10 to any neighboring cells. At step 308, the SNPN 20 may redirect the non-subscribed UE 10 to other SNPNs 20 that are in an agreement with the home service provider of the non-subscribed UE 10. At step 310, the SNPN 20 may send a radio release control (RRC) Release message to the non-subscribed UE 10 to release the non-subscribed UE 10 to an idle state. At step 312, the SNPN 20 may send the RRCRelease message with one or more suspend configuration parameters to release the non-subscribed UE 10 to an inactive state.

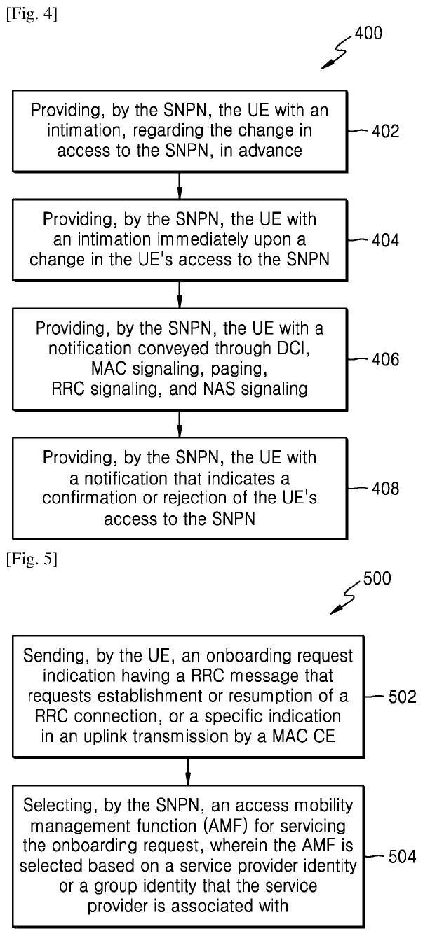

FIG. 4 illustrates a method 400 by which the SNPN 20 notifies the UE 10 of a change in the UE's 10 access to the SNPN 20. At step 402, the SNPN 20 may provide the UE 10 with an intimation, in advance, regarding a change in the UE's 10 access to the SNPN 20. At step 404, the SNPN 20 may provide the UE 10 with an intimation immediately upon a change in the UE's 10 access to the SNPN 20. At step 406, the SNPN 20 may provide the UE 10 with a notification conveyed through downlink control information (DCI), medium access control (MAC) signaling, paging, RRC signaling, and NAS signaling. At step 408, the SNPN 20 may provide the UE 10 with a notification that indicates a confirmation or rejection of the UE's 10 access to the SNPN 20.

FIG. 5 illustrates a method 500 by which the SNPN 20 services an onboarding request from the UE 10. At step 502, the UE may send to the SNPN 20 an onboarding request indication having a RRC message that requests establishment or resumption of a RRC connection, or a specific indication in an uplink transmission by a MAC CE. At step 504, the SNPN 20 may select an access mobility management function (AMF) for servicing the onboarding request, wherein the AMF is selected based on a service provider identity or a GID that the UE's subscription provider is associated with.

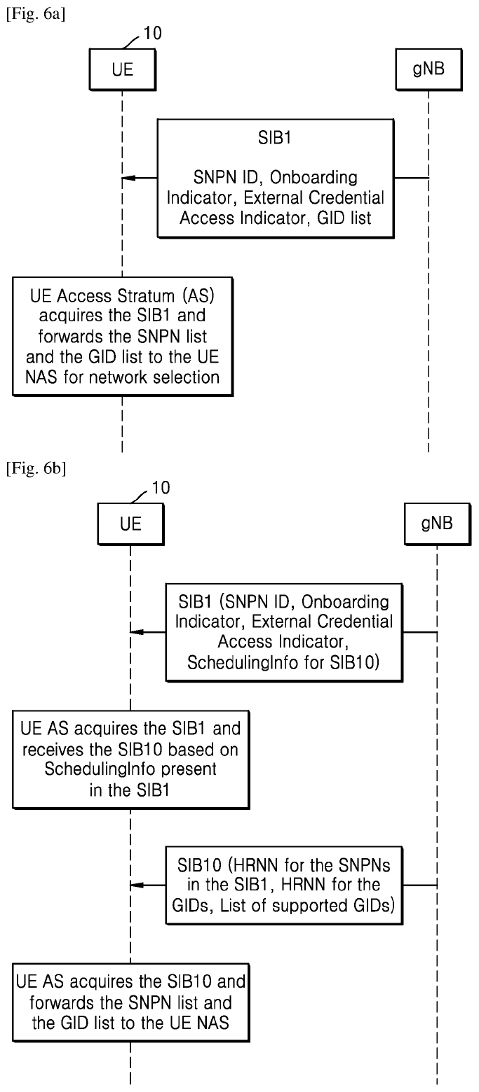

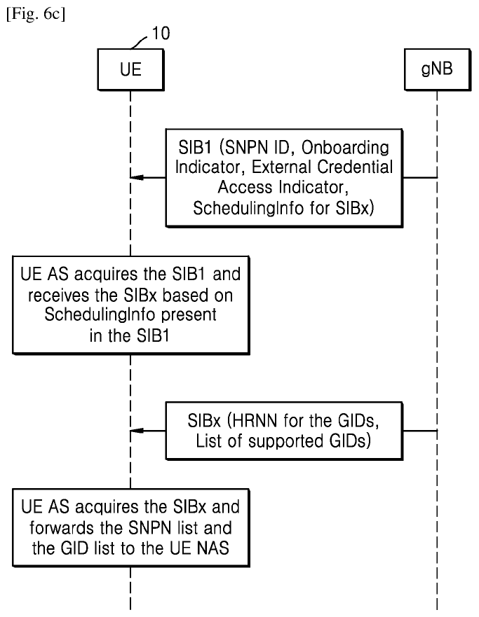

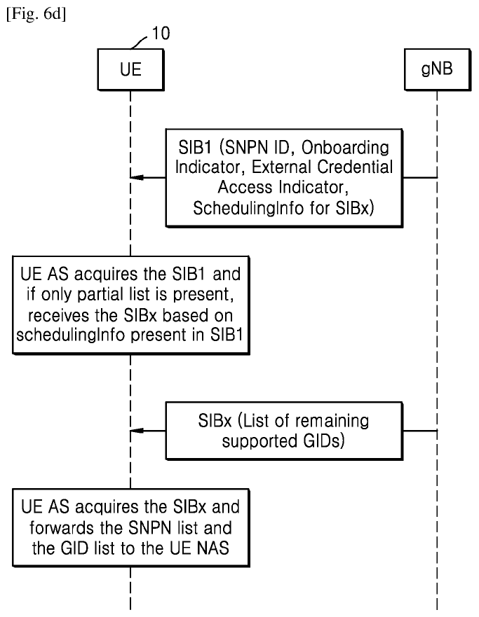

FIG. 6a illustrates a signaling flow by which the gNB may broadcast the list of supported GIDs in the SIB1 40 and the UE 10 may acquire the list to perform network selection to gain access to services provided by the SNPN 20. The UE 10 may forward the group identities for network selection (GINs) received in the SIB1 40 with the corresponding SNPN identities to the upper layers comprising the Non-Access Stratum (NAS) layer.

FIG. 6b illustrates a signaling flow by which the gNB may broadcast the scheduling information for the SIB10 42 in the SIB1 40 and the list of supported GIDs in the SIB10 42, and the UE 10 may acquire the list to perform network selection to gain access to services provided by the SNPN 20. The UE 10 may forward the group identities for network selection (GINs) received in the SIB10 42 with the corresponding SNPN identities to the upper layers comprising the Non-Access Stratum (NAS) layer.

FIG. 6c illustrates a signaling flow by which the gNB may broadcast the scheduling information for the SIBx 44 in the SIB1 40 and the list of supported GIDs in the SIBx 44, and the UE 10 may acquire the list to perform network selection to gain access to services provided by the SNPN 20. The UE 10 may forward the group identities for network selection (GINs) received in the SIBx 44 with the corresponding SNPN identities to the upper layers comprising the Non-Access Stratum (NAS) layer.

FIG. 6d illustrates a signaling flow by which the gNB may broadcast a partial list of GIDs in the SIB1 40 and the remaining list of supported GIDs in the SIBx 44, and the UE 10 may acquire the list to perform network selection to gain access to services provided by SNPN 20. The UE 10 may forward the group identities for network selection (GINs) received in the SIB1 40 and/or SIBx 44 with the corresponding SNPN identities to the upper layers comprising the Non-Access Stratum (NAS) layer.

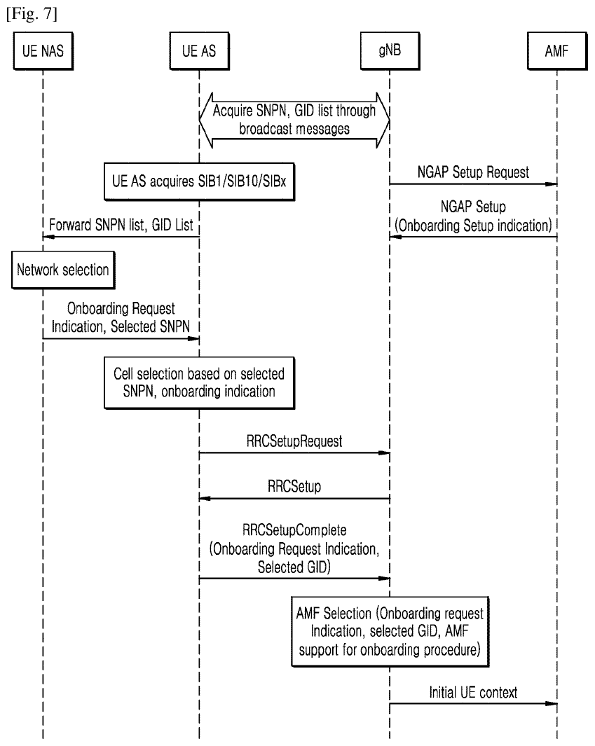

FIG. 7 illustrates a signaling flow by which the UE may perform connection establishment for onboarding procedure and may indicate that the connection is for onboarding purpose. The UE AS may determine whether the upper layers comprising the UE NAS layer provide an onboarding request indication, and send an onboarding request indication in a radio resource control (RRC) message that requests establishment or resumption of a RRC connection, or a specific indication in an uplink transmission by a medium access control (MAC) control element (CE), and in response to determining the upper layers comprising the UE NAS layer, provide an onboarding request indication. The RRC message can be either a RRCSetupComplete message or a RRCResumeComplete message. FIG. 7 also depicts the AMF selection for onboarding performed at the network using the onboarding indicator sent by the UE 10 and the AMF's indication of its support for onboarding.

The various actions in methods 200, 300, 400, and 500 may be performed in the order presented, in a different order or simultaneously. Further, in some embodiments, some actions listed in FIGS. 2 to 5 may be omitted.

The embodiments disclosed herein can be implemented through at least one software program running on at least one hardware device (an example of which is the user equipment) and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

1-15. (canceled)

16. A method performed by a user equipment (UE) in a wireless communication system, the method comprising:
receiving system information block (SIB) including information regarding one or more group IDs for network selection (GINs), wherein the information regarding the one or more GINs indicates the one or more GINs supported by one or more stand-alone non-public networks (SNPNs); and
forwarding, from an access stratum (AS) of the UE to a non-access stratum (NAS) of the UE, the information regarding the one or more GINs with one or more corresponding SNPN identities.

17. The method of claim 16, the method further comprising:
receiving, from a base station (BS), an radio resource control (RRC) setup message; and
transmitting, to the BS, an RRC setup complete message including a onboarding request, the onboarding request indicating that connection establishment is for onboarding.

18. The method of claim 16, the method further comprising:
selecting a SNPN.

19. A method performed by a base station (BS) in a wireless communication system, the method comprising:
transmitting, to a user equipment (UE), system information block (SIB) including information regarding one or more group IDs for network selection (GINs),
wherein the information regarding the one or more GINs indicates the one or more GINs supported by one or more stand-alone non-public networks (SNPNs) and is forwarded from an access stratum (AS) of the UE to a non-access stratum (NAS) of the UE.

20. The method of claim 19, the method further comprising:
transmitting an radio resource control (RRC) setup message to the UE; and
receiving an RRC setup complete message including a onboarding request, the onboarding request indicating that connection establishment is for onboarding.

21. A user equipment (UE) in a wireless communication system, the UE comprising:
a transceiver; and
a processor coupled with the transceiver and configured to:
receive system information block (SIB) including information regarding one or more group IDs for network selection (GINs), wherein the information regarding the one or more GINs indicates the one or more GINs supported by one or more stand-alone non-public networks (SNPNs),
forward, from an access stratum (AS) of the UE to a non-access stratum (NAS) of the UE, the information regarding the one or more GINs with one or more corresponding SNPN identities.

22. The method of claim 21, the method further comprising:
receiving, from a base station (BS), an radio resource control (RRC) setup message; and
transmitting, to the BS, an RRC setup complete message including a onboarding request, the onboarding request indicating that connection establishment is for onboarding.

23. The method of claim 21, the method further comprising:
selecting a SNPN.

24. A base station (BS) in a wireless communication system, the BS comprising:
a transceiver; and
a processor coupled with the transceiver and configured to transmit, to a user equipment (UE), system information block (SIB) including information regarding one or more group IDs for network selection (GINs),
wherein the information regarding the one or more GINs indicates the one or more GINs supported by one or more stand-alone non-public networks (SNPNs) and is forwarded from an access stratum (AS) of the UE to a non-access stratum (NAS) of the UE.

25. The BS of claim 24, wherein the transceiver is further configured to:
transmit an radio resource control (RRC) setup message to the UE, and
receive an RRC setup complete message including a onboarding request, the onboarding request indicating that connection establishment is for onboarding.
